(19) United States
(12) Patent Application Publication
(10) Pub. No.: US 2014/0292163 A1
(43) Pub. Date: Oct. 2, 2014

(54) ELECTRIC MOTOR WITH COOLING APPARATUS

(71) Applicant: Johnson Electric S.A., Murten (CH)

(72) Inventors: James Ching Sik LAU, Hong Kong (CN); Xiaojun YANG, Shenzhen (CN)

(73) Assignee: Johnson Electric S.A., Murten (CH)

(21) Appl. No.: 14/226,624

(22) Filed: Mar. 26, 2014

(30) Foreign Application Priority Data
Mar. 26, 2013 (CN) 201310101033.0

(51) Int. Cl. H02K 9/06; H02K 9/22

(52) U.S. Cl. CPC H02K 9/06; H02K 9/22
USPC 310/60 R

(57) ABSTRACT

A motor (10) comprises a stator (30) and a rotor (50) configured to rotate inside the stator (30). A heat sink (40) has a base portion (42) disposed around and thermally connected to an outer surface of the stator (30) and a plurality of cooling fins (44) extending from the base portion (42). A centrifugal fan (70) is attached to one end of an output shaft (52) of the rotor (50), positioned such that the heat sink (40) is near an axial end of the fan (70). During operation, the centrifugal fan (70) generates an air flow over the heat sink (40), thus providing cooling for the motor (10).

### CROSS REFERENCE TO RELATED APPLICATION(S)

This application claims the benefit of Chinese patent application serial no. 201310101033.0, filed on Mar. 26, 2013. The entire content of the aforementioned patent application is hereby incorporated by reference for all purposes.

### BACKGROUND

Heat generated during the operation of an electric motors by various components of the motor can potentially cause damage and reduce the operational lifetime of the motor. Thus, cooling is an important consideration in the design of electric motors. Many conventional electric motors contain one or more air cooling passages formed inside the motor. A fan located on an end cap of the motor creates air flow through the cooling passages, thereby cooling the motor. However, in many compact and high performance motors, the space within the motor may be limited, not conducive to air flow, or otherwise unsuitable for forming internal cooling passages. As a result, the motor may overheat due to insufficient cooling, which reduces the operational life of the motor.

Accordingly, there exists a need for electric motors having improved cooling properties so as to reduce the negative effects caused by overheating.

### SUMMARY

Some embodiments are directed at an electric motor having a stator and a rotor configured to rotate relative to the stator. A heat sink is provided on an outer surface or sidewall of the stator, and positioned adjacent to a first axial end of a fan attached to an output shaft of the rotor. The heat sink comprises a substantially cylindrical base portion and a plurality of cooling fins circumferentially spaced around the base portion extending in the axial direction. The fan may be a centrifugal fan, configured to create an air flow comprising a first portion flowing towards the fan and a second portion substantially perpendicular in direction to the first portion flowing away from the fan, such the first portion flows over the heat sink and absorbs heat from the heat sink.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered which are illustrated in the accompanying drawings. These drawings depict only exemplary embodiments and are not therefore to be considered limiting of the scope of the claims.

FIG. 1 illustrates a motor having a closed end cap in accordance with some embodiments.

FIG. 2 illustrates a motor in accordance with some embodiments, with an end cap removed in order to illustrate the internal structure of the motor.

FIG. 3 illustrates a motor having an open end cap in accordance with some embodiments.

FIG. 4 illustrates a motor having a circuit board in accordance with some embodiments.

FIG. 5 illustrates a motor in accordance with an alternate embodiment.

FIG. 6 illustrates a power tool incorporating a motor in accordance with some embodiments.

### DETAILED DESCRIPTION

Various features are described hereinafter with reference to the figures. It shall be noted that the figures are not drawn to scale, and that the elements of similar structures or functions are represented by like reference numerals throughout the figures. It shall also be noted that the figures are only intended to facilitate the description of the features for illustration and explanation purposes, unless otherwise specifically recited in one or more specific embodiments or claimed in one or more specific claims. The drawings figures and various embodiments described herein are not intended as an exhaustive illustration or description of various other embodiments or as a limitation on the scope of the claims or the scope of some other embodiments that are apparent to one of ordinary skills in the art in view of the embodiments described in the Application. In addition, an illustrated embodiment need not have all the aspects or advantages shown.

An aspect or an advantage described in conjunction with a particular embodiment is not necessarily limited to that embodiment and may be practiced in any other embodiments, even if not so illustrated, or if not explicitly described. Also, reference throughout this specification to “some embodiments” or “other embodiments” means that a particular feature, structure, material, process, or characteristic described in connection with the embodiments is included in at least one embodiment. Thus, the appearances of the phrase “in some embodiments”, “in one or more embodiments”, or “in other embodiments” in various places throughout this specification are not necessarily referring to the same embodiment or embodiments.

Some embodiments are directed at an electric motor having a stator and a rotor configured to rotate relative to the stator. A heat sink is provided on an outer surface or sidewall of the stator, and positioned adjacent to a first axial end of a fan attached to an output shaft of the rotor. The heat sink comprises a substantially cylindrical base portion and a plurality of cooling fins circumferentially spaced around the base portion extending in the axial direction. The fan may be a centrifugal fan, configured to create an air flow comprising a first portion flowing towards the fan and a second portion substantially perpendicular in direction to the first portion flowing away from the fan, such the first portion flows over the heat sink and absorbs heat from the heat sink.

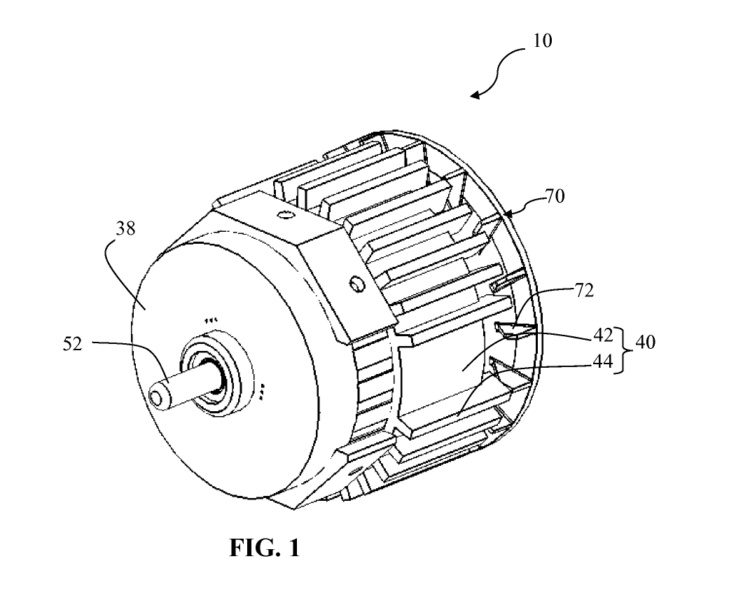

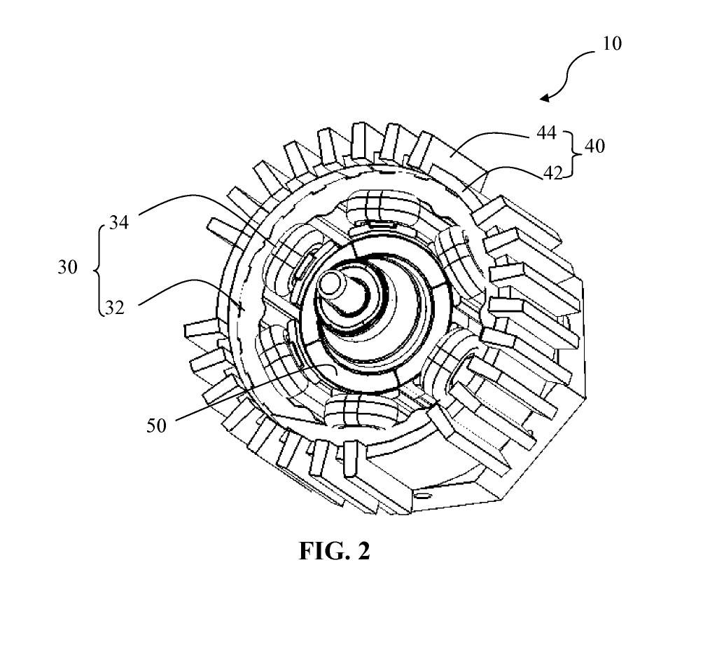

FIGS. 1 and 2 illustrate an electric motor 10 in accordance with some embodiments. Motor 10 comprises a stator 30 and rotor 50. In some embodiments, motor 10 is a brushless electric motor, wherein stator 30 is located outside rotor 50. It is understood that in other embodiments, other types of electric motors or different motor configurations may be used (e.g., brushed electric motors).

Stator 30 comprises a stator core 32 and a plurality of winding groups 34. Stator core 32 may comprise a substantially cylindrical stator yoke and a plurality of stator teeth that extend radially inwards from an inner surface of the stator yoke, allowing for winding groups 34 to be wound around the plurality of stator teeth. An outer surface of the stator yoke forms a sidewall of stator 30 between its two axial ends.

A heat sink 40 is located adjacent to the outer surface of the yoke of stator core 32 or the sidewall of stator 30, and comprises a base portion 42 and a plurality of cooling fins 44 circumferentially spaced around an outer surface of base portion 42. Cooling fins 44 extend radially outward and axially along base portion 42. Base portion 42 may have a shape configured to correspond to the outer surface of the yoke of stator core 32 (e.g., substantially cylindrical).

Base portion 42 of heat sink 40 is configured to enclose stator core 32, such that the outer surface of stator core 32 is adjacent to the inner surface of base portion 42. This enables the heat generated by winding groups 34 to efficiently spread to base portion 42 of heat sink 40 through stator core 32, where it may be dissipated through cooling fins 44. In some embodiments, a thermally conductive material (e.g., thermal paste or epoxy) is applied between the outer surface of stator core 32 and the inner surface of base portion 42, and to where winding groups 34 connect with stator core 32, aiding in the rapid transfer of heat from winding groups 34 to stator core 32 and to heat sink 40. In other embodiments, heat sink 40 and stator core 32 may be integrally formed.

In some embodiments, a fan 70 is attached to one end of rotor 50, e.g., attached to an axial end of an output shaft 52, and comprises a plurality of fan blades 72. Fan blades 72 are configured to have a diameter greater than a diameter of base portion 42 of heat sink 40, located on an axial side of fan 70. In some embodiments, fan 70 is a centrifugal fan, such that during operation a suction effect is created causing an input air flow towards fan 70 from one or both axial ends of fan 70, and is output from fan 70 in directions substantially perpendicular to the axial input directions.

During operation, fan 70 creates a suction effect, resulting in air flowing from a side of heat sink 40 remote from fan 70, through the gaps between cooling fins 44, and towards fan 70. Thus, heat from cooling fins 44 is carried away by the air flow created by fan 70 flowing across heat sink 40.

In some embodiments, stator 30 further comprises one or two end caps covering one or both axial ends thereof. By way of example, FIG. 1 shows motor 10 having an end cap 38 covering an axial end remote from fan 70. As illustrated in FIG. 1, end cap 38 may be a closed end cap, configured to substantially seal the interior of motor 10, such that air flow paths are only formed externally to stator core 32. Using a closed end cap 38 prevents outside particles and dust from entering the interior of motor 10, which may be beneficial if motor 10 is used in applications that involve dust or other airborne particles (e.g., an electric drill). In some embodiments, an outer surface of end cap 38 is used to mount electronic components such as, for example, transistors. Air flow generated by fan 70 may flow over the electronic components mounted on end cap 38 in order to provide cooling to the electronic components.

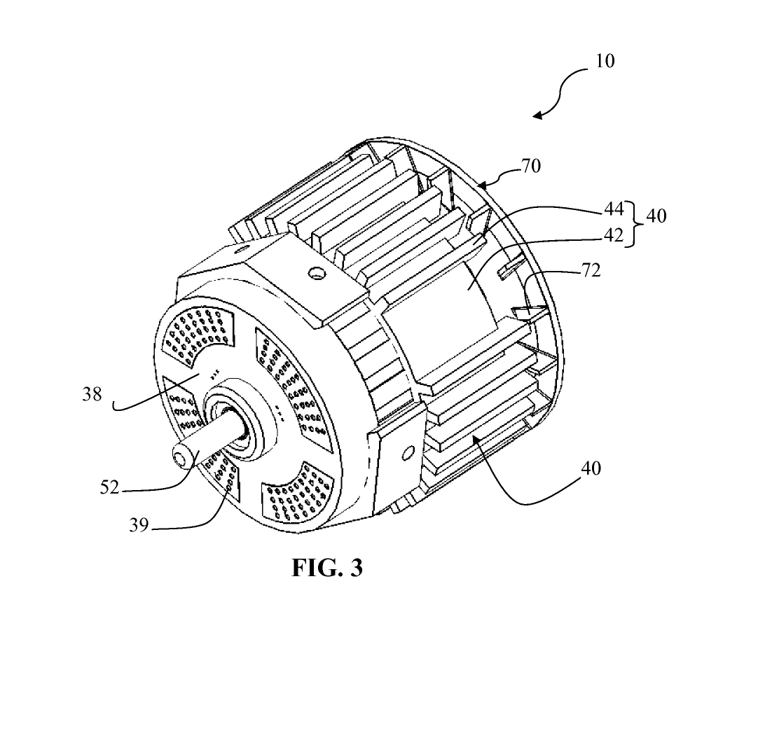

It is understood that in some embodiments, end cap 38 may not be closed. For example, as illustrated in FIG. 3, end cap 38 is open, comprising one or more small axial bores 39 allowing for air flow through one or more internal paths of motor 10. This may further improve the heat dissipation properties of motor 10. The size of bores 39 may be configured to be small enough to prevent dust and other external particles from entering motor 10.

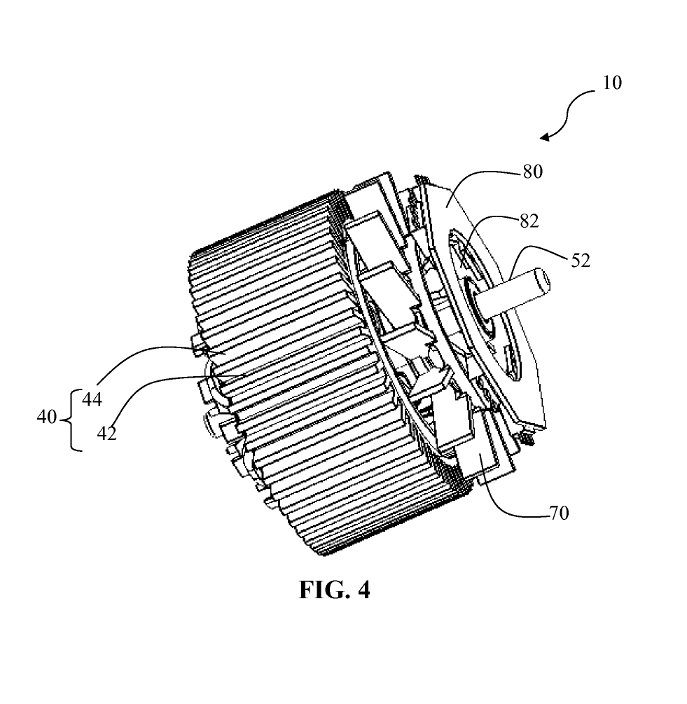

As illustrated in FIG. 4, motor 10 may further comprise a circuit board 80, wherein fan 70 is positioned between heat sink 40 surrounding stator core 32 and circuit board 80. In some embodiments, circuit board 80 is substantially ring-shaped, and contains at least one opening 82, allowing output shaft 52 to pass through. During operation, fan 70 generates a first suction air flow flowing over heat sink 40 as described above, providing cooling for heat sink 40, and a second suction air flow flowing around circuit board 80 and through opening 82, providing cooling for the electronic components on circuit board 80.

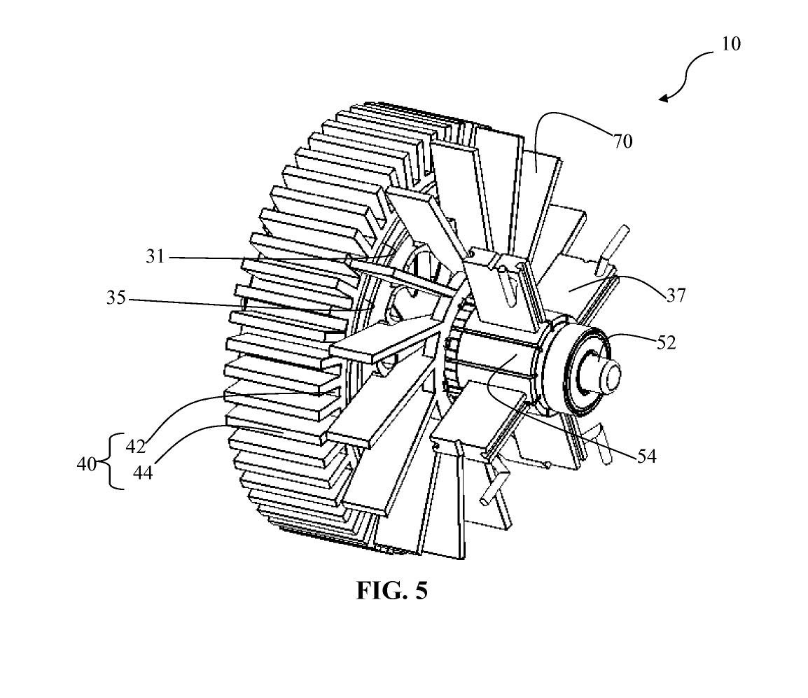

FIG. 5 illustrates a brushed motor 10 in accordance with an alternate embodiment. Motor 10 comprises a stator 30 having a shell 31 and one or more permanent magnets 35. Permanent magnets 35 are thermally connected to an inner surface of shell 31. An outer surface of shell 31 forms a sidewall of stator 30 between its two axial ends. Heat sink 40 is located outside shell 31, such that an inner surface of heat sink 40 is adjacent to or abutting the outer surface of shell 31. In a preferred embodiment, heat sink 40 comprises a substantially cylindrical base portion 42 and a plurality cooling fins 44 extending outwards from base portion 42 in the radial direction.

In the embodiment illustrated in FIG. 5, rotor 50 comprises output shaft 52 and a commutator 54 fixed to output shaft 52. In addition, stator 30 further comprises a plurality of electric brushes 37 configured to be in sliding contact with commutator 54. In some embodiments, fan 70 is located between heat sink 40 and electric brushes 37. During operation, fan 70 generates a first suction air flow flowing over heat sink 40 towards a first axial end of fan 70, providing cooling for heat sink 40, and a second suction air flow flowing over commutator 54 and electric brushes 37 towards a second axial end of fan 70, providing cooling for commutator 54 and electric brushes 37.

Motor 10 may be configured so that both ends thereof are sealed, such that the air flow paths are external to motor 10, preventing dust and other external particles from entering motor 10. Alternatively, the one or both ends of motor 10 may be open, such that at least a portion of the air flow generated by fan 70 travels through one or more internal cooling passages of motor 10, further improving its heat dissipation properties. In some embodiments, heat sink 40 may be integrally formed with shell 31, or be attached to shell 31 through a variety of existing installation methods. In some embodiments, a thermally conductive material, such as thermal paste or epoxy, may be applied between the inner surface of base portion 42 of heat sink 40 and the outer surface of shell 31.

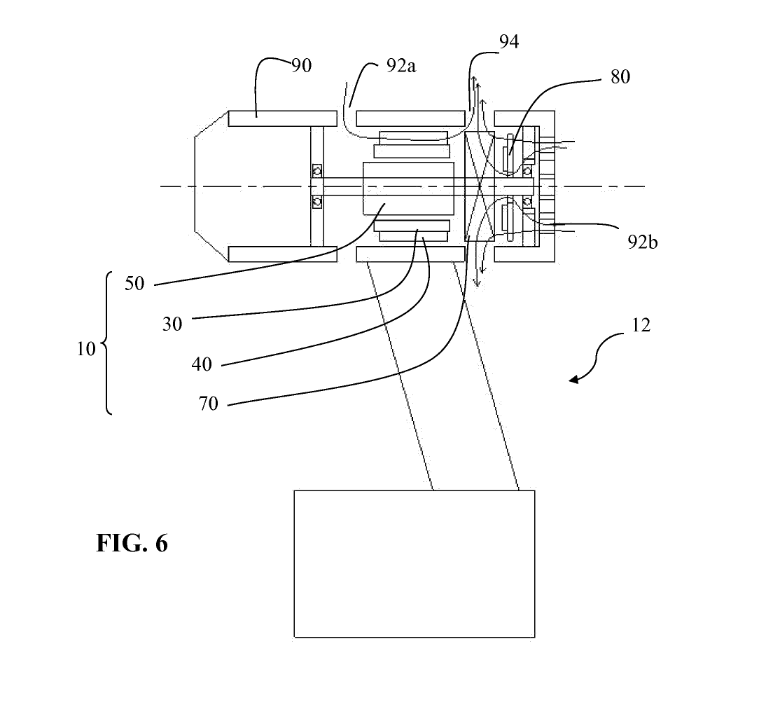

Electric motor 10 described herein above with reference to FIGS. 1-5 may be used in a variety of different appliances, such as a blender or power tool. By way of example, FIG. 6 illustrates a power tool 12 incorporating motor 10 in accordance with some embodiments. Power tool 12 comprises a housing 90 having a plurality of air inlets 92a and 92b, and one or more of air outlets 94. Motor 10 is housed within housing 90, and positioned such that fan 70 is located adjacent to air outlets 94. For example, air outlets 94 may be positioned between a first and second axial ends of fan 70, such that the air flow from centrifugal fan 70 is substantially perpendicular to the axial direction of motor 10 and directed towards air outlets 94. Air inlets 92a are adjacent to a first axial end of motor 10 (e.g., the axial end near heat sink 40); while air inlets 92b are adjacent to the opposite axial end of motor 10 (e.g., the axial end near circuit board 80). In some embodiments, air inlets 92b are located on an axial end of housing 90.

During operation, fan 70 generates an air flow entering housing 90 through air inlets 92a, flowing over heat sink 40 (e.g., through the gaps between cooling fins 44 of heat sink 40), and exiting housing 90 through air outlets 94, thus providing cooling to heat sink 40. Fan 70 also generates an air flow entering housing 90 through air inlets 92b, flowing around circuit board 80, and exiting housing 90 through air outlets 94, providing cool to circuit board 80. Thus fan 70 may be used to provide cooling for motor 10 as well as for other electric components (e.g., electronic components on circuit board 80) in power tool 12.

In the foregoing specification, various aspects have been described with reference to specific embodiments thereof. It will, however, be evident that various modifications and changes may be made thereto without departing from the broader spirit and scope of various embodiments described herein. For example, the above-described systems or modules are described with reference to particular arrangements of components. Nonetheless, the ordering of or spatial relations among many of the described components may be changed without affecting the scope or operation or effectiveness of various embodiments described herein. In addition, although particular features have been shown and described, it will be understood that they are not intended to limit the scope of the claims or the scope of other embodiments, and it will be clear to those skilled in the art that various changes and modifications may be made without departing from the scope of various embodiments described herein. The specification and drawings are, accordingly, to be regarded in an illustrative or explanatory rather than restrictive sense. The described embodiments are thus intended to cover alternatives, modifications, and equivalents.

1. An electric motor, comprising:
a stator having a first axial end, a second axial end, and a sidewall there between;
a rotor comprising a rotor core rotatably disposed in the stator and an output shaft having a first end and a second end extending through the first axial end and the second axial end, respectively, of the stator;
a heat sink disposed on the sidewall of the stator; and
a centrifugal fan attached to the output shaft adjacent to the first end thereof and configured to generate an air flow comprising a first portion flowing over the heat sink toward the centrifugal fan and a second portion flowing away from the centrifugal fan, the second portion of the air flow being substantially perpendicular to the first portion of the air flow.

2. The electric motor of claim 1, further comprising:
a commutator attached to the output shaft of the rotor adjacent the first end thereof and at a side of the centrifugal fan remote from the heat sink; and
a plurality of electric brushes attached to the stator adjacent the first axial end thereof and in sliding contact with the commutator.

3. The electric motor of claim 2, wherein the air flow generated by the centrifugal fan further comprises a third portion flowing over the commutator toward the centrifugal fan in a direction substantially opposite to that of the first portion of the air flow.

4. The electric motor of claim 1, wherein the stator comprises:
a yoke having an outer surface forming the sidewall of the stator;
a plurality of stator teeth extending radially inwards from the yoke; and
a plurality of windings wound around the plurality of stator teeth.

5. The electric motor of claim 1, wherein the heat sink comprises a substantially cylindrical base abutting the sidewall of the stator and a plurality of cooling fins circumferentially spaced around the substantially cylindrical base.

6. The electric motor of claim 1, further comprising a thermally conductive material applied between the sidewall of the stator and the heat sink.

7. The electric motor of claim 1, further comprising at least one end cap located on at least one of the first and second axial ends of stator.

8. The electric motor of claim 7, wherein the at least one end cap contains at least one axial bore permitting air to flow within an interior of the stator.

9. The electric motor of claim 7, wherein the at least one end cap is a closed end cap.

10. The electric motor of claim 1, further comprising an electronic component disposed adjacent to a side of the centrifugal fan remote from the heat sink.

11. The electric motor of claim 10, wherein the air flow generated by the centrifugal fan further comprises a third portion flowing over the electronic component toward the centrifugal fan in a direction substantially opposite to that of the first portion of the air flow.

12. An electrical appliance, comprising:
a housing having an air inlet and an air outlet;
an electric motor accommodated within the housing, comprising:
a stator having a first axial end adjacent the air inlet, a second end, and a sidewall there between;
a rotor comprising a rotor core rotatably disposed in the stator and an output shaft having a first end and a second end extending through the first axial end and the second axial end, respectively, of the stator;
a heat sink disposed on sidewall of the stator; and
a centrifugal fan attached to the output shaft adjacent to the second end thereof and configured to generate an air flow comprising a first portion flowing from the air inlet over the heat sink toward the centrifugal fan and a second portion flowing away from the centrifugal fan to the air outlet, wherein the second portion of the air flow is substantially perpendicular to the first portion of the air flow.

13. The electrical appliance of claim 12, wherein the air outlet is located between two axial ends of the centrifugal fan.

14. The electrical appliance of claim 12, further comprising an electronic component disposed on the stator adjacent the second axial end and at a side of the centrifugal fan remote from the heat sink.

15. The electrical appliance of claim 14, wherein:
the housing further comprises a second air inlet adjacent to the second end of the stator; and
the air flow generated by the centrifugal fan further comprises a third portion flowing from the second air inlet over the electronic component toward the centrifugal fan in a direction substantially opposite to that of the first portion of the air flow.

16. The electrical appliance of claim 15, wherein the second air inlet is located on an axial end of the housing substantially perpendicular to the output shaft of rotor of the electric motor.

17. The electrical appliance of claim 12, wherein the electric motor further comprises:
a commutator attached to the output shaft of the rotor adjacent the second end thereof and at a side of the centrifugal fan remote from the heat sink; and
a plurality of electric brushes attached to the stator adjacent the second axial end thereof and in sliding contact with the commutator.

18. The electrical appliance of claim 12, wherein the heat sink comprises a substantially cylindrical base abutting the sidewall of the stator and a plurality of cooling fins circumferentially spaced around the substantially cylindrical base.

19. The electrical appliance of claim 12, wherein the electric motor further comprises a thermally conductive material applied between the sidewall of the stator and a radial inner surface of the heat sink.

20. The electrical appliance of claim 12, wherein the electrical appliance is a power tool.
